(19) United States
(12) Patent Application Publication
(10) Pub. No.: US 2026/0029357 A1
(43) Pub. Date: Jan. 29, 2026

(54) NON-DESTRUCTIVE IMAGING OF POLAR DOMAINS AND CRYSTALLOGRAPHIC SYMMETRY IN THE SCANNING ELECTRON MICROSCOPE

(71) Applicant: University of Southern California, Los Angeles, CA (US)

(72) Inventors: Jayakanth RAVICHANDRAN, Los Angeles, CA (US); Yu-Tsun SHAO, Los Angeles, CA (US); Amir AVISHAI, Los Angeles, CA (US); Ann NGO, Los Angeles, CA (US)

(73) Assignee: University of Southern California, Los Angeles, CA (US)

(21) Appl. No.: 19/282,300

(22) Filed: Jul. 28, 2025

Related U.S. Application Data
(60) Provisional application No. 63/675,780, filed on Jul. 26, 2024.

(51) Int. Cl. G01N 23/20058; G01N 23/203

(52) U.S. Cl. CPC G01N 23/20058; G01N 23/203; G01N 2223/418; G01N 2223/646

(57) ABSTRACT

A system for non-destructive imaging of polar domains and crystallographic symmetry includes a source of a focused electron beam and a sample holder configured to hold a sample at a position such that the focused electron beam is incident on the sample at a probe position. The sample holder holds the sample at an angle with respect to the focused electron beam. The EBSD system also includes an imaging detector configured to receive diffracted electrons from the sample that are resolvable into a first wave vector component along a first direction and a second wave vector component along a second direction. Characteristically, the first direction is orthogonal to the second direction. The EBSD system also includes a translation stage that moves the sample holder such that positions from the sample are sampled and a computer processor-based controller configured to move the translation stage and collect output from the imaging detector.

### CROSS-REFERENCE TO RELATED APPLICATIONS

This application claims the benefit of U.S. provisional application Ser. No. 63/675,780 filed Jul. 26, 2024, the disclosure of which is hereby incorporated in its entirety by reference herein.

### TECHNICAL FIELD

In at least one aspect, the present invention relates to a system and method for non-destructive imaging of polar domains and crystallographic symmetry in a sample.

### BACKGROUND

The ability to engineer and manipulate polarization domains is essential for tailoring the properties of ferroelectric materials, which have potential applications in next-generation nanodevices. The mechanical and electrostatic boundary conditions at interfaces strongly affect both the domain structure and phase instabilities in ferroelectric films [1,2]. These domains are regions where the polarization vectors are locally aligned in distinct directions as constrained by crystallographic symmetry. Thus, being able to image the polarity non-destructively allows us to visualize and characterize the size, shape, and distribution of ferroelectric domains, providing insights into structure-property relations.

Scanning probe microscopy (SPM)-based techniques such as piezo response force microscopy (PFM) is a popular technique for imaging ferroelectric domains non-destructively at the nanoscale. In PFM, the polarization direction can be obtained based on the interaction between the tip and the surface polarization, yet susceptible to artifacts such as poor tip shape, sample preparation, or surface charges. Another common technique for domain characterization is based on diffraction contrast transmission electron microscopy (TEM) imaging, which often requires thinning the specimen down to below 100 nm. The contrast for different polar domains in dark-field TEM imaging is based on dynamical diffraction effects, which causes intensity asymmetry of Friedel pairs, IG^{→} and I-G^{→}. Interestingly, dynamical diffraction effects are also observed in electron backscatter diffraction (EBSD) patterns in a scanning electron microscope (SEM) for chiral [3] and polar crystals [4].

Accordingly, there is a need for improved methods of analyzing electron beam diffraction patterns.

### SUMMARY

In at least one aspect, the present invention provides methodology to image the ferroelectric polar domains in a non-destructive fashion, using a combination of machine learning methods for analyzing large datasets obtained by backscattered electron diffraction patterns in the scanning electron microscope (SEM). Advantageously, this opens up a new means for metrology potentially applicable to beyond-CMOS devices.

In another aspect, a non-destructive, electron diffraction imaging (DREDI) system (e.g., depth-resolved) for imaging of polar domains and crystallographic symmetry is provided. The DREDI system includes a source of a focused electron beam and a sample holder configured to hold a sample at a position such that the focused electron beam is incident on the sample at a probe position. Moreover, the sample holder is configured to orient a sample at a selectable angle relative to the focused electron beam at a probe position. The DREDI system also includes an imaging detector configured to receive diffracted electrons from the sample that are resolvable into wave-vector components along mutually orthogonal first and second directions (e.g., a first wave vector component along a first direction and a second wave vector component along a second direction). Characteristically, the first direction is orthogonal to the second direction. The DREDI system also includes a translation stage that moves the sample holder such that a plurality of positions from the sample are sampled and a computer processor-based controller is configured to move the translation stage and collect output from the imaging detector. The computer processor based-controller or another computing device is configured to image and/or identify polar domains and crystallographic symmetry in a sample.

In another aspect, the depth-resolved electron diffraction imaging system is an electron backscatter diffraction system.

In another aspect, the DREDI technique is applied to probe sub-surface nanodomain structures in multiferroic BiFeO₃ thin films is provided. DREDI leverages asymmetries in Kikuchi band intensities arising from dynamical diffraction that are sensitive to the local polarization orientations. By systematically tuning the incident electron energy, the interaction-volume depth is varied, producing tomographic slices of the polarization distribution with lateral resolution better than 50 nm and depth resolution better than 10 nm, each acquired in less than a second. Examination of a 30 nm-thick BiFeO₃ film shows a depth-dependent evolution of polarization domains: bifurcated three-fold vertices near the bottom interface, quadrant vortex domains within the interior, and regular 71° stripe domains near the top surface. The DREDI approach achieves this three-dimensional mapping without physical sectioning or thinning and is fully compatible with intact, grounded samples, providing a practical, non-destructive means to visualize polarization configurations under native boundary conditions.

In another aspect, an imaging detector configured to receive diffracted electrons resolvable into wave-vector components along mutually orthogonal first and second directions;

In another aspect, an DREDI method for non-destructive imaging of polar domains and crystallographic symmetry is provided. The method includes a step of directing a focused electron beam onto a sample held at a probe position by a sample holder where the sample holder maintains the sample at an angle with respect to the focused electron beam. Diffracted electrons are received from the sample with an imaging detector that resolves them into a first wave vector component along a first direction and a second wave vector component along a second direction. Characteristically, the first direction is orthogonal to the second direction. The sample holder is moved (e.g., translated) to sample a plurality of positions from the sample using a translation stage. Output from the imaging detector is collected with a computer processor-based controller. The polar domains and the crystallographic symmetry are imaged and/or identified in the sample using the computer processor-based controller or another computing device.

In another aspect, the DREDI method is applied to directly image polarity in InP, as well as domain structures in BaTiO₃ and BiFeO₃ films.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

For a further understanding of the nature, objects, and advantages of the present disclosure, reference should be made to the following detailed description, read in conjunction with the following drawings, wherein like reference numerals denote like elements and wherein:

FIG. 1A. Schematic illustration of the SEM setup showing multiple types of scattered electrons and corresponding detectors.

FIG. 1B. Schematic of the EBSD geometry. Four-dimensional datasets (x, y, kₓ, k_{y}) were acquired using a CMOS detector

FIGS. 2A, 2B, 2C, and 2D. Non-destructive polarization imaging using a scanning electron microscope. (A) Schematic illustration of the SEM setup showing multiple types of scattered electrons and corresponding detectors. (B) Schematic representations of BiFeO₃ crystal structure (left) and four polarization directions along (right). (C) Secondary electron image acquired using an Everhart-Thornley detector (ETD) from a BiFeO₃/SrRuO₃/DyScO₃ heterostructure, exhibiting contrast associated with out-of-plane polarization. (D) ABS electron image from the same region as in C, revealing polarization domain contrast. The arrows indicate polarization directions. The ‘pc’ denotes for pseudocubic. Both scale bars in (C, D) represent 1 μm.

FIGS. 3A, 3B, 3C, 3D, 3E, and 3F. (A) Non-destructive polarization imaging from Friedel symmetry breaking using electron backscatter diffraction (EBSD). A Schematic of the EBSD geometry. Four-dimensional datasets (x, y, kₓ, k_{y}) were acquired using a CMOS detector. Reconstructed from the EBSD datasets, 109° ferroelectric domain configuration in BiFcO₃ is shown (B). (C) Difference map between domain 1 and 2, as labelled in (B). (D) Enlarged area of electron backscattered patterns difference, yellow box in (C). (E) Corresponding line profile of (D). Intensity asymmetries in the Kikuchi bands highlighted with arrows indicate direct evidence of Friedel symmetry breaking in non-centrosymmetric BiFeO₃. (F) Dynamical Bloch-wave simulation reproduces similar Kikuchi band asymmetries, supporting the experimental observations. Scale bars in (C, D) represent 50 and 20 mrad, respectively.

FIGS. 4A, 4B, 4C, 4D, 4E, 4F, 4G, 4H, and 4I. and. Depth-resolved imaging of 3D polar domains. (A) Schematic of the 30 nm BiFcO₃/30 nm SrRuO₃/DyScO₃ heterostructure geometry, illustrating Monte Carlo-simulated electron generation volume at 2 kV (green), 5 kV (blue) and 10 kV (red). The BiFeO₃/SrRuO₃ heterostructure is grown on a DyScO₃ substrate with out-of-plane orientation of [001]ₒ/[100]_{pc}. Voltage-dependent ABS image series acquired at 2 kV, 5 kV, and 10 kV (B-D), corresponding to different visible depths of the same region, reveal consistent strip-like domain patterns along the z-direction of the thin film. Corresponding ABS image series of frustrated BiFeO₃ area (E-G) revealing depth-dependent variations in the polarization domain structure across the film thickness. Scale bars in (B-G) represent 500 nm. Cross-sectional dark-field (DF) 4D-STEM of the stripe region (H, corresponding to B-D) and that of the frustrated region (I, corresponding to E-G), shows contrasting BiFeO₃ and SrRuO₃ twinning domain distributions. DF-STEM reveals periodic twinning in the stripe region (H) and distorted twinning patterns in the frustrated region (I). Scale bars in (H, I) represent 100 nm.

FIGS. 5A and 5B. Embedded polar vortices. DREDI revealed 3D domains evolve from vertices to vortex domains along the out-of-plane direction. ABS image series acquired at 5 kV (A) and 15 kV (B) of the same region. With larger visible depth (bottom), two 3-fold vertices were observed (A). A different domain pattern of a single 4-fold vertex (B) was observed near the surface. Right column: schematic representations of two 3-fold vertices and 4-fold vertex domain configurations. Scale bars in (A, B) represent 200 nm.

### DETAILED DESCRIPTION

Reference will now be made in detail to presently preferred embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

When referring to a numerical quantity, in a refinement, the term “less than” includes a lower non-included limit that is 5 percent of the number indicated after “less than.” A lower non-includes limit means that the numerical quantity being described is greater than the value indicated as a lower non-included limited. For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, 1 percent, or 0 percent of the number indicated after “less than.”

With respect to electrical devices, the term “connected to” means that the electrical components referred to as connected to are in electrical communication. In a refinement, “connected to” means that the electrical components referred to as connected to are directly wired to each other. In another refinement, “connected to” means that the electrical components communicate wirelessly or by a combination of wired and wirelessly connected components. In another refinement, “connected to” means that one or more additional electrical components are interposed between the electrical components referred to as connected to with an electrical signal from an originating component being processed (e.g., filtered, amplified, modulated, rectified, attenuated, summed, subtracted, etc.) before being received to the component connected thereto.

The term “electrical communication” means that an electrical signal is either directly or indirectly sent from an originating electronic device to a receiving electrical device. Indirect electrical communication can involve processing of the electrical signal, including but not limited to, filtering of the signal, amplification of the signal, rectification of the signal, modulation of the signal, attenuation of the signal, adding of the signal with another signal, subtracting the signal from another signal, subtracting another signal from the signal, and the like. Electrical communication can be accomplished with wired components, wirelessly connected components, or a combination thereof.

The term “one or more” means “at least one” and the term “at least one” means “one or more.” The terms “one or more” and “at least one” include “plurality” as a subset.

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within +0%, 0.1%, 0.5%, 1%, 2%, 3%, 4%, 5% or 10% of the value or relative characteristic.

It is recognized that the controllers as disclosed herein may include various microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, such controllers as disclosed utilize one or more microprocessors to execute a computer-program that is embodied in a non-transitory computer readable medium that is programmed to perform the functions as disclosed. Further, the controller(s) as provided herein includes a housing and the various number of microprocessors, integrated circuits, and memory devices ((e.g., FLASH, random access memory (RAM), read only memory (ROM), electrically programmable read only memory (EPROM), electrically erasable programmable read only memory (EEPROM)) positioned within the housing. The controller(s) as disclosed also include hardware based inputs and outputs for transmitting and receiving data, respectively, to and from other hardware based devices as discussed herein.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

Throughout this application, where publications are referenced, the disclosures of these publications in their entireties are hereby incorporated by reference into this application to more fully describe the state of the art to which this invention pertains.

### Abbreviations:

“ABS” means segmented annular backscatter.

“DREDI” means non-destructive, depth-resolved electron diffraction imaging.

“EBSD” means electron backscatter diffraction.

“kₓ” is the x component of the wave vector.

“k_{y}” is the x component of the wave vector.

“SEM” means scanning electron microscope.

“TEM” means transmission electron microscopy.

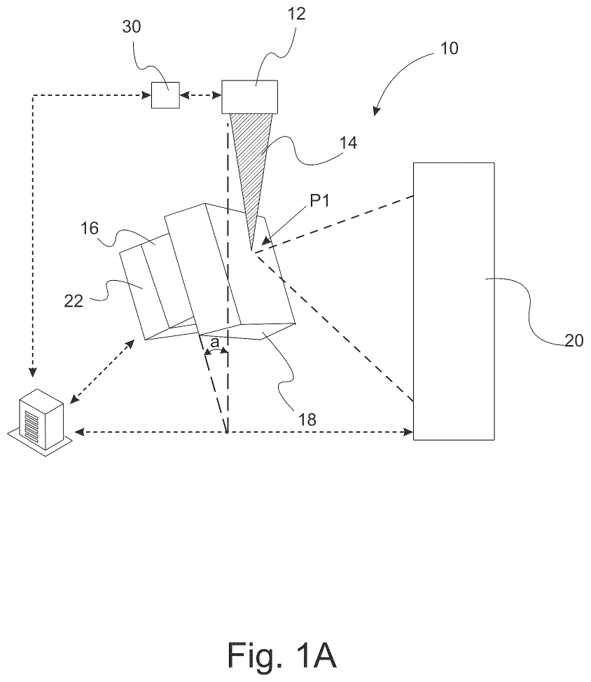

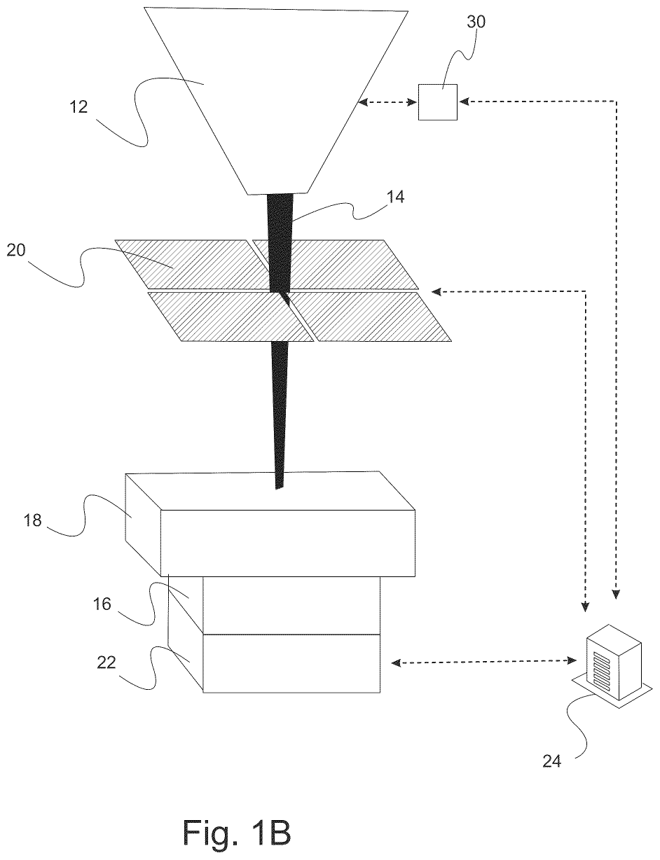

With respect to FIGS. 1A and 1B, schematics of a system for non-destructive imaging of polar domains and crystallographic symmetry is provided. EBSD 10 includes a source 12 of a focused electron beam 14 and a sample holder 16 configured to hold sample 18 at a position such that the focused electron beam is incident on sample 18 at a probe position P1. In a refinement, the sample is a ferromagnet. Examples of electron sources include thermionic electron sources, field emission electron sources, lanthanum hexaboride sources, and cold cathode electron sources, and the like. Sample holder 16 holds sample 18 at an angle a (e.g., from 5 to 75°, typically 70°) with respect to the focused electron beam 14. EBSD system 10 also includes an imaging detector 20 configured to receive diffracted electrons from sample 18 that are resolvable into a first wave vector component (e.g., kₓ) along a first direction and a second wave vector component (e.g., k_{y}) along a second direction. Examples of imaging detectors include CMOS cameras, scintillation screen/phosphor screen detectors, photographic film, image plates, microchannel plate detectors, electron-induced fluorescence detectors, electron energy-loss spectroscopy detectors, electron-beam position-sensitive detectors, electron-backscatter diffraction detectors, and combinations thereof.

Characteristically, the first direction is orthogonal to the second direction. EBSD system 10 also includes a translation stage 22 that moves the sample holder 16 such that a plurality of positions from the sample is sampled. Computer processor-based controller 24 is configured to move the translation stage and collect output from the imaging detector. Therefore, computer processor-based controller 24 can be configured to be in electrical communication with source 12, imaging detector 20, and translation stage 22. Typically, the computer processor based-controller is further configured to image and/or identify polar domains and crystallographic symmetry in a sample.

FIG. 1A depicts the variation in which sample holder 16 holds sample 18 at an angle a (e.g., from 5 to 75°, typically 70°) with respect to the focused electron beam 14. FIG. 1B depicts the variation in which sample holder 16 holds sample 18 normally (i.e., at a normal angle or perpendicular) with respect to the focused electron beam 14. In this variation, the imaging detector includes a plurality of image-sensing elements. (e.g., Timepix detector). [6]

In another aspect, the system 10 further includes a beam-energy control circuit 30 configured to cause the source 12 to adjust the accelerating voltage of the focused electron beam among multiple, suitably spaced set-points. By cycling the beam through these different voltages, the circuit enables the electron-sample interaction volume to shift to progressively greater depths, allowing the apparatus to interrogate and image subsurface regions of the specimen without physical sectioning. In a refinement, beam-energy control circuit 30 causes the source 12 to supply the focused electron beam with at least two accelerating-voltage set-points that differ by at least one kilovolts and span a range of electron landing energies from about 2 kV to about 25 kV, thereby probing successively deeper interaction volumes within the sample. For example, beam-energy control circuit 30 can send a digital code to a DAC. The DAC can drive the high-voltage power supply in the electron-beam source 12. A microcontroller changes the code to move between preset voltages. A feedback divider and ADC confirm each voltage and signal when it is stable. During each change the controller blanks the beam. Once stable it unblanks the beam, triggers the detector, and records the voltage. Rapid stepping lets the system capture a full tomographic stack in seconds. In a refinement, beam-energy set-points can be chosen such that Monte-Carlo-simulated maximum electron-generation depths differ by ≥10 nm.

In another aspect, the computer processor-based controller 24 is configured to register diffraction data acquired at a plurality of accelerating-voltage set-points and to generate tomographic slices of the sample. In a refinement, each tomographic slice generated by the computer processor-based controller has a lateral spatial resolution such that structures of size 50 nm or smaller can be resolved and a depth resolution such that structures of size 10 nm or smaller can be resolved. Typically, the data is acquired in less than one second. However, the data acquisition time can be seconds, minutes, or hours.

In another aspect, when the sample is a non-centrosymmetric crystal with the polar axis lying in the mirror plane in the corresponding Kikuchi pattern, the computer processor-based controller 24 (or another computing device) is configured to derive polarity from intensity asymmetry. In a refinement, controller 24 (or another computing device) is configured to map vortex, vertex and stripe polar textures across the film thickness. In one refinement, the controller 24 (or another computing device) is programmed not only to generate tomographic slices but also to analyze those slices so it can identify and render three characteristic polar-domain patterns through the film thickness. These include vortex textures, where polarization vectors curl around a central axis; vertex textures, where three or more domain walls meet at a point; and stripe textures (i.e. periodic parallel domain walls that in rhombohedral BiFeO₃ are typically 71° or 109° walls.) By classifying each depth slice into one of these categories and stacking the results, the controller produces a three-dimensional map that shows how vortex, vertex, and stripe domains evolve from the substrate interface to the film surface.

In another aspect, computer processor-based controller 24 or another computing device is configured to identify the polar domains and the crystallographic symmetry by examining intensity asymmetries in electron backscatter diffraction (EBSD) patterns, interpreting variations in the EBSD patterns to determine an orientation and distribution of the polar domains, and assessing symmetry based on diffraction features and their deviations from expected symmetrical behavior. In a refinement, the presence and orientation of polar domains can be detected by examining the intensity asymmetries in the electron backscatter diffraction (EBSD) Kikuchi patterns. This process begins with the EBSD system 10 collecting diffraction patterns from various points on the sample surface, each sensitive to the crystal's orientation and structure, producing unique Kikuchi patterns. In non-centrosymmetric crystals, polar domains cause asymmetries in these patterns' intensity. By analyzing these variations, regions can be identified with different polar orientations. Comparative analysis across different sample regions highlights significant intensity differences and pattern variations, mapping the boundaries and orientations of polar domains. Symmetry assessment of the Kikuchi patterns further reveals deviations from expected symmetrical behavior, indicating the presence and orientation of polar axes. This data is then used to create a detailed, non-destructive map of the polar domains, showing their distribution and orientation across the sample surface, providing insights into the material's structural properties and behavior.

In another aspect, the computer processor-based controller or another computing device is configured to apply clustering analysis to provide contrasts that correspond to different types of Kikuchi patterns.

In another aspect, the computer processor-based controller 24 or another computing device is configured to apply clustering analysis to provide contrasts that correspond to different types of Kikuchi patterns. In a refinement, the clustering analysis is selected from k-means clustering, hierarchical clustering, density-based spatial clustering of applications with noise (BSCAN), mean shift clustering, agglomerative clustering, balanced iterative reducing and clustering using hierarchies (BIRCH), gaussian mixture model (GMM), ordering points to identify clustering structure (OPTICS), spectral clustering, affinity propagation, and combinations thereof. K-means clustering is found to be particularly useful.

In another aspect, the imaging detector 20 is configured to receive the diffracted electrons as one or more electron backscatter diffraction (EBSD) datasets. In a refinement, the computer processor-based controller 24 or another computing device is configured to apply principal component analysis (PCA) and/or a k-means clustering to the EBSD datasets. In a refinement, PCA is applied to reduce dimensionality of the one or more EBSD datasets by identifying and projecting onto principal components that capture a maximum variance or have a value greater than a predetermined variance, thereby simplifying the data while retaining essential features for further analysis.

In another aspect, the k-means clustering is performed (typically on pca-denoised data) by a method including steps of initializing a predetermined number of cluster centroids using an optimized seeding method to improve accuracy of cluster formation and assigning each data point within imaging data to a nearest cluster centroid based on a distance metric that accounts for specific characteristics of Kikuchi patterns. Each cluster centroid is updated by calculating a weighted mean of the data points assigned to a respective centroid, where weights are determined based on intensity and spatial distribution of the Kikuchi patterns. The method further includes steps of iterating the assignment and update steps until a convergence criterion is met. In a refinement, the convergence criterion includes minimizing variance within each cluster and maximizing the variance between clusters. Advantageously, results from k-means clustering provide enhancing contrasts that correspond to different types of Kikuchi patterns, thereby enabling imaging of the polar domains and the crystallographic symmetry in the sample.

In another aspect, principal component analysis (PCA) is combined with k-means clustering for the imaging and/or identification of polar domains and crystallographic symmetry in a scanning electron microscope to significantly enhance the analysis and visualization of complex EBSD datasets. Initially, the EBSD data, which typically comprises numerous diffraction patterns, needs to be standardized to ensure each feature has a mean of zero and a standard deviation of one. This standardization is crucial for preparing the data for PCA. Once the data is standardized, PCA is applied to reduce its dimensionality and optionally to reduce noise. This involves calculating the covariance matrix of the standardized data, performing eigen decomposition to identify the eigenvalues and eigenvectors, and selecting the principal components that capture the most variance. The selected principal components are used to transform the original high-dimensional data into a lower-dimensional space. This transformation not only reduces the complexity of the data but also retains the most significant variations, making subsequent analyses more manageable. Following PCA, k-means clustering is applied to the transformed data. The number of clusters, k, is chosen based on prior knowledge or methods such as the elbow method or silhouette analysis. The k-means algorithm is then run on the PCA-transformed data to identify clusters. Each cluster represents a group of similar diffraction patterns or polar domains. After clustering, the results are analyzed by examining the cluster centers in the reduced PCA space to understand the key features of each cluster. Each original data point is assigned to a cluster based on the k-means results. Visualization of the clustering results is facilitated by plotting the clusters in two or three dimensions using the first two or three principal components. This visual representation helps in identifying clusters, trends, and anomalies in the EBSD patterns. Post-clustering, it is essential to interpret the results to understand the different types of Kikuchi patterns and their relation to the polar domains and crystallographic symmetry. Validation of the clustering results can be done using techniques like silhouette scores or comparing with known classifications. The combination of PCA and k-means clustering offers several benefits. PCA reduces the dimensionality and complexity of the data, making the clustering process more efficient and effective. It also helps in filtering out noise, leading to more accurate clustering results. The visualization of reduced-dimensional data makes it easier to interpret the clustering results, and PCA's feature extraction capabilities enhance the clustering process by identifying the most significant features. Overall, this combined approach allows for a more efficient and effective classification and analysis of complex EBSD data, providing deeper insights into polar domains and crystallographic symmetry.

In another aspect, the computer processor-based controller 24 or another computing device is configured to compare intensity differences of Kikuchi patterns from a plurality of regions to verify polar domains and the corresponding breaking of Friedel symmetry. In a refinement, controller 24 is configured to determine polarity by comparing Kikuchi-band intensity asymmetries that break Friedel symmetry across the beam-energy series.

In ferroelectrics, the configuration of polarization domains has a strong impact on their properties. Understanding the detailed configuration and interaction of these nanodomains is crucial, as it directly influences the material's piezoelectric, dielectric, and ferroelectric performance. Technologically, precise imaging and characterization of these domains enable the optimization of device performance in applications such as sensors, actuators, and non-volatile memory devices. like dielectric permittivity and switching dynamics that are important for next-generation electronic and ultrasound applications. The fragmented nature of nanometer-sized polar domains presents a significant challenge for characterization, which often relies on invasive metrology methods like transmission electron microscopy (TEM) that requires thinning the specimen down to electron transparency (<100 nm). The imaging method, by incorporating machine learning algorithms (e.g., k-means clustering, PCA) for analyzing electron backscatter diffraction (EBSD) data, allows for high-resolution visualization of these domains. Moreover, by incorporating SEM sample stages with biasing, cooling or heating capabilities, this non-destructive method can serve as a platform for operando imaging of the domain evolution under device working conditions (external bias and/or at controlled temperatures). Such an operando metrology platform, enabled by the non-destructive method, is expected to provide fundamental insights into the failure mechanism in ferroelectric nanodevices that are unavailable otherwise.

In another embodiment, a method for non-destructive imaging of polar domains and crystallographic symmetry with the EDBS system described above is provided. The method includes a step of directing a focused electron beam onto a sample held at a probe position by a sample holder where the sample holder maintains the sample at an angle with respect to the focused electron beam. Diffracted electrons are received from the sample with an imaging detector that resolves them into a first wave vector component along a first direction and a second wave vector component along a second direction. Characteristically, the first direction is orthogonal to the second direction. The sample holder is moved (e.g., translated) to sample a plurality of positions from the sample using a translation stage. Output from the imaging detector is collected with a computer processor-based controller. The polar domains and the crystallographic symmetry are imaged and/or identified in the sample using the computer processor-based controller or another computing device.

In another aspect, the method further includes a step of stepping an electron landing energy through a plurality of values between 2 kV and 25 kV, wherein for each voltage, acquiring an EBSD or ABS dataset is acquired and stored in association with interaction-depth metadata.

In another aspect, the method further includes a step of identifying the polar domains and the crystallographic symmetry by examining intensity asymmetries in electron backscatter diffraction (EBSD) patterns, interpreting variations in the EBSD patterns to determine an orientation and distribution of the polar domains, and assessing symmetry based on diffraction features and their deviations from expected symmetrical behavior. In a refinement, the method includes a step of applying clustering analysis using the computer processor-based controller or another computing device to provide contrasts that correspond to different types of Kikuchi patterns. As set forth above, the clustering analysis can be selected from the group consisting of k-means clustering, hierarchical clustering, density-based spatial clustering of applications with noise (BSCAN), mean shift clustering, agglomerative clustering, balanced iterative reducing and clustering using hierarchies (BIRCH), Gaussian mixture model (GMM), ordering points to identify clustering structure (OPTICS), spectral clustering, affinity propagation, and combinations thereof.

In another aspect, the method includes a step of receiving the diffracted electrons as one or more electron backscatter diffraction (EBSD) datasets with the imaging detector. In a refinement, the method further includes a step of applying principal component analysis (PCA) and/or k-means clustering to the EBSD datasets using the computer processor-based controller or another computing device. Details of the PCA and the k-means clustering are described above as well as other aspects of the method.

The following examples illustrate the various embodiments of the present invention. Those skilled in the art will recognize many variations that are within the spirit of the present invention and scope of the claims.

### 1. Electron Backscattered Electron Diffraction

Electron backscattered electron diffraction (EBSD) data were acquired at a working distance of 4 mm, with the sample mounted on a standard 70° pre-tilted stub to enhance pattern acquisition efficiency. No additional surface preparation was performed, in order to preserve the atomically smooth morphology of the as-grown films with surface roughness of ˜0.5 Å rms. Measurements were conducted using a Thermo Scientific Helios G4 UXe PFIB system equipped with an Oxford Symmetry S2 with a CMOS detector. An accelerating voltage of 5-10 kV and a beam current of 26 nA were used to improve the signal-to-noise ratio. Scans were performed with a step size of 10-50 nm over a 10×10 μm² area. Dynamical diffraction simulations of Kikuchi patterns were carried out using AztecCrystal software using the Bloch-wave algorithm. Post-processing of the 4D EBSD datasets—comprising full Kikuchi diffraction patterns (kₓ, k_{y}) acquired at each scan position (x, y)—was performed using principal component analysis (PCA) and k-means clustering. The first 30 components were selected from the PCA analysis to reduce noise in the raw patterns. The subsequent denoised data were used as input for k-means clustering to segment different regions in the BFO thin film into distinct crystallographic domains. The number of clusters was determined empirically by evaluating the pattern variance across different regions and selecting the value that yielded physically meaningful domain boundaries. Both PCA and clustering were implemented using custom Python scripts.

2. Annular Backscatter and kV-Sweep

Backscattered electron (BSE) imaging was performed using the Thermo Scientific Helios G4 UXe PFIB system, which is equipped with an immersion lens mode and a retractable, segmented annular backscatter (ABS) detector. For ABS imaging, the sample is mounted flat, with the ABS detector positioned coaxially with the incident electron beam path along the [110], zone axis (i.e., growth direction or plan-view). Along this zone axis, the intensity asymmetry in the Kikuchi bands along the polar axes can be detected by the segmented ABS detectors. ABS images were acquired using a beam current of 0.8 nA and a dwell time of 5 μs. A series of images was collected over a range of accelerating voltages from 2 kV to 25 kV to investigate voltage-dependent contrast behavior.

### 3. Results

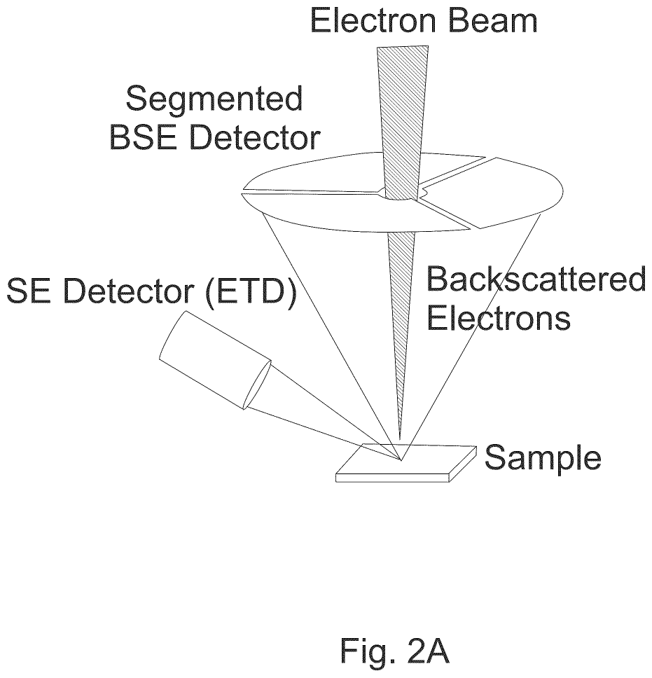

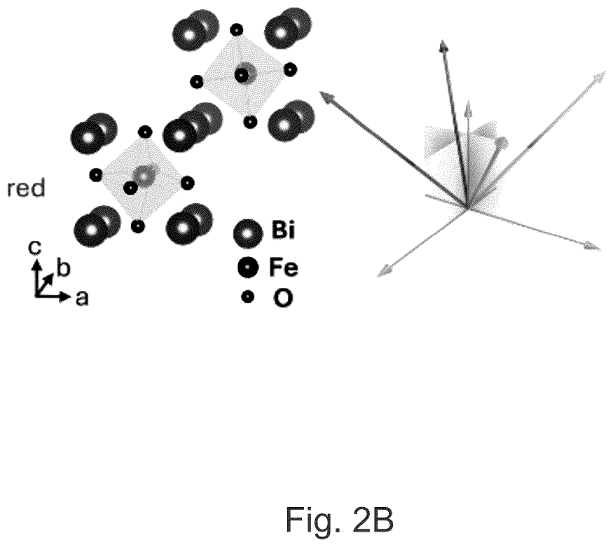

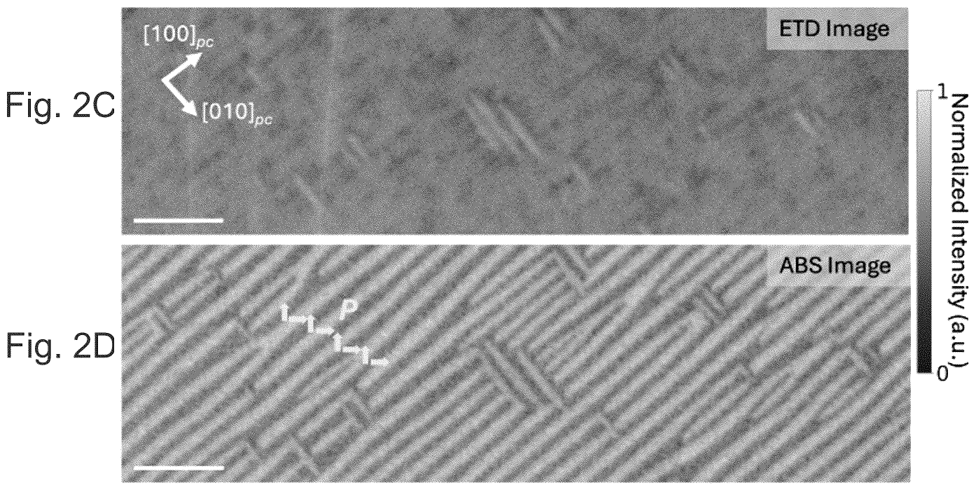

The experimental setup employed a scanning electron microscope configured with multiple detectors to capture various types of scattered electrons, as illustrated schematically in the system diagram (FIG. 2A). The BiFeO₃ crystal structure, with its characteristic perovskite lattice, exhibits four distinct polarization directions along the crystallographic axis (FIG. 2B). When examining a BiFeO₃/SrRuO₃/DyScO₃ heterostructure using an Everhart-Thornley detector (ETD), the secondary electron image revealed contrast variations associated with out-of-plane polarization components (FIG. 2C). The same region, when imaged using the annular backscatter (ABS) electron detector, displayed pronounced polarization domain contrast with arrows indicating the local polarization directions (FIG. 2D). Both imaging modes captured the same 1 μm field of view, with the pseudocubic (pc) notation used for crystallographic reference (FIG. 2C, D). This comparative imaging approach demonstrates how different electron detection modes can reveal complementary information about ferroelectric domain structures in these complex oxide heterostructures.

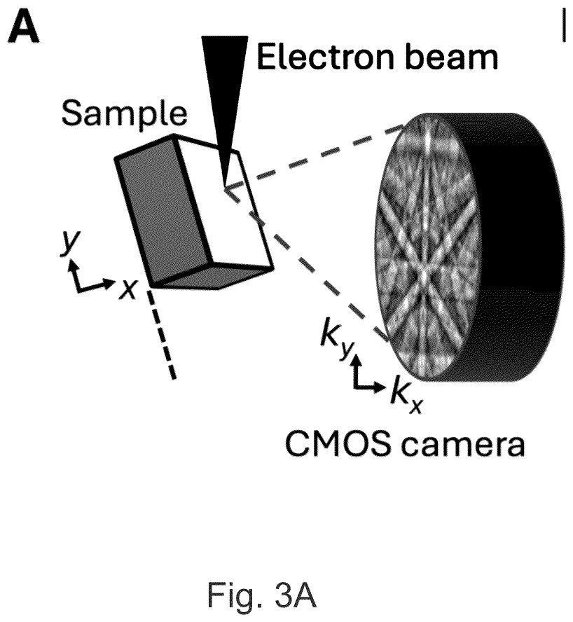

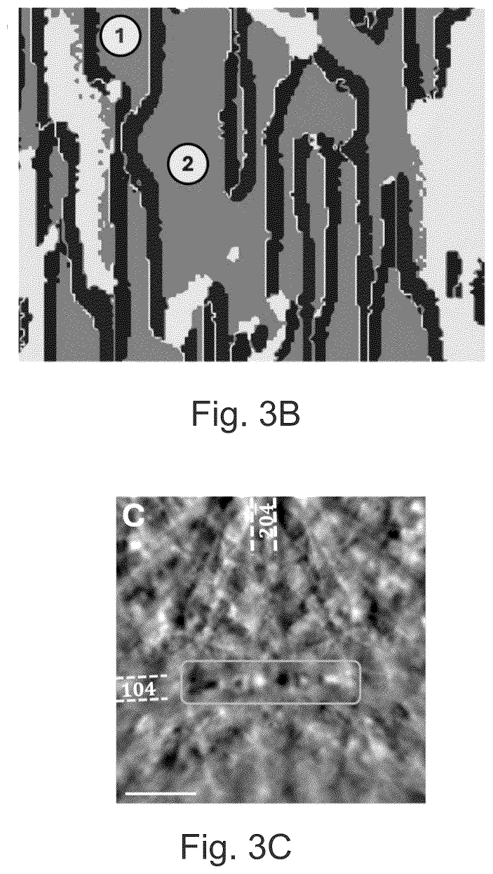

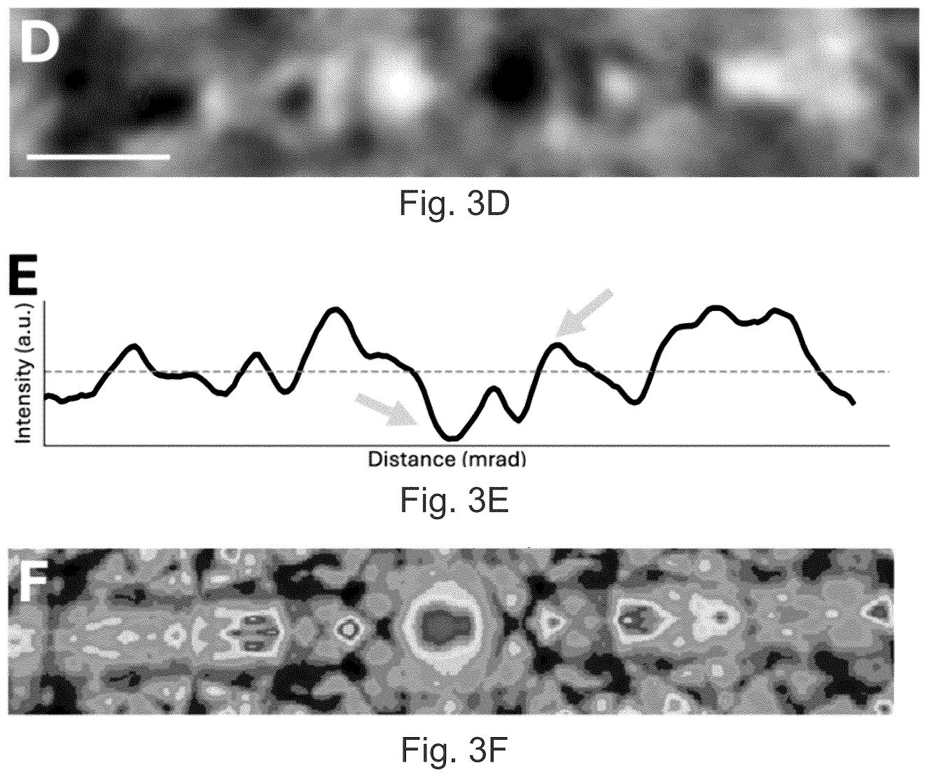

The electron backscatter diffraction (EBSD) technique employs a specific geometric configuration where four-dimensional datasets capturing both real-space positions (x, y) and reciprocal-space information (kₓ, k_{y}) are acquired using a CMOS detector (FIG. 3A). Analysis of these 4D-EBSD datasets revealed the characteristic 109° ferroelectric domain configuration in BiFeO₃ (FIG. 3B). To identify the crystallographic differences between domains, a difference map was generated by comparing the Kikuchi patterns from domains 1 and 2 as labeled in the reconstructed image (FIG. 3C). Closer examination of the difference patterns, particularly in the enlarged region marked by the yellow box, exposed distinct intensity variations across the Kikuchi bands (FIG. 3D). The corresponding line profile clearly demonstrates these intensity asymmetrics, with arrows highlighting the specific Kikuchi bands that exhibit direct evidence of Friedel symmetry breaking—a hallmark of the non-centrosymmetric nature of BiFeO₃ (FIG. 3E). These experimental observations were validated through dynamical Bloch-wave simulations, which successfully reproduced the observed Kikuchi band asymmetrics, providing theoretical support for the symmetry-breaking signatures detected experimentally (FIG. 3F). The angular resolution of this technique is evident in the scale bars, representing 50 and 20 mrad for the full and enlarged difference maps, respectively (FIG. 3C, D).

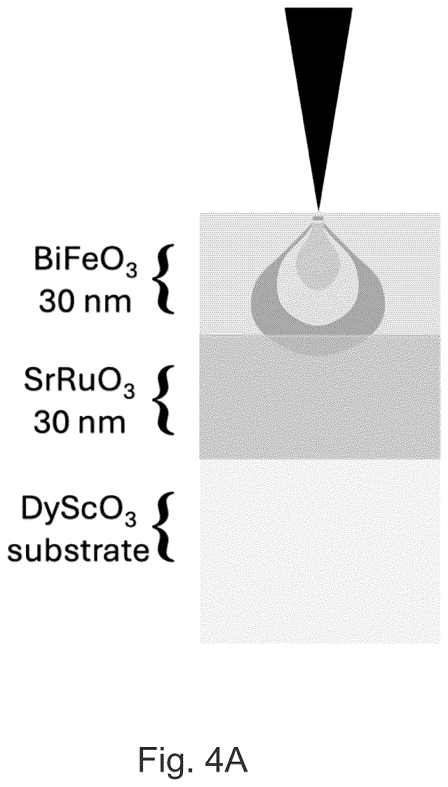

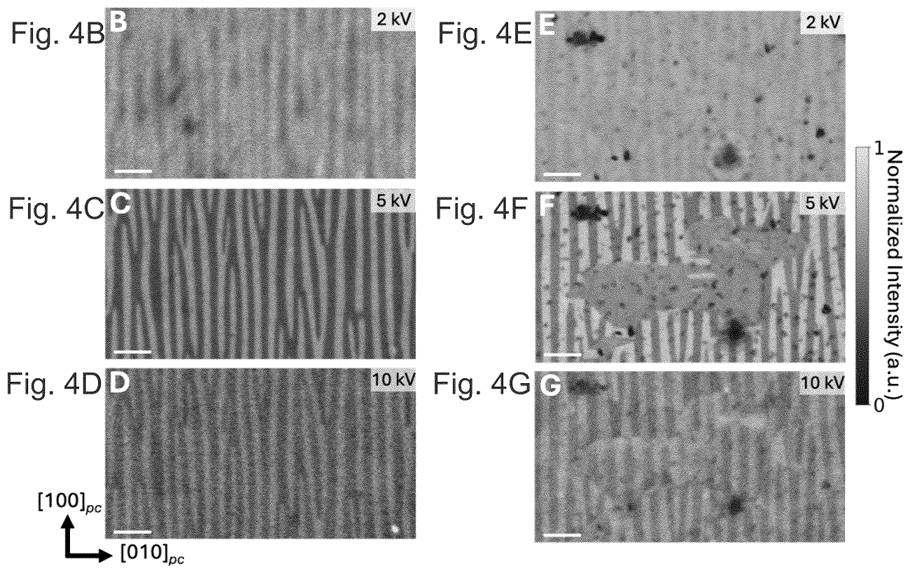

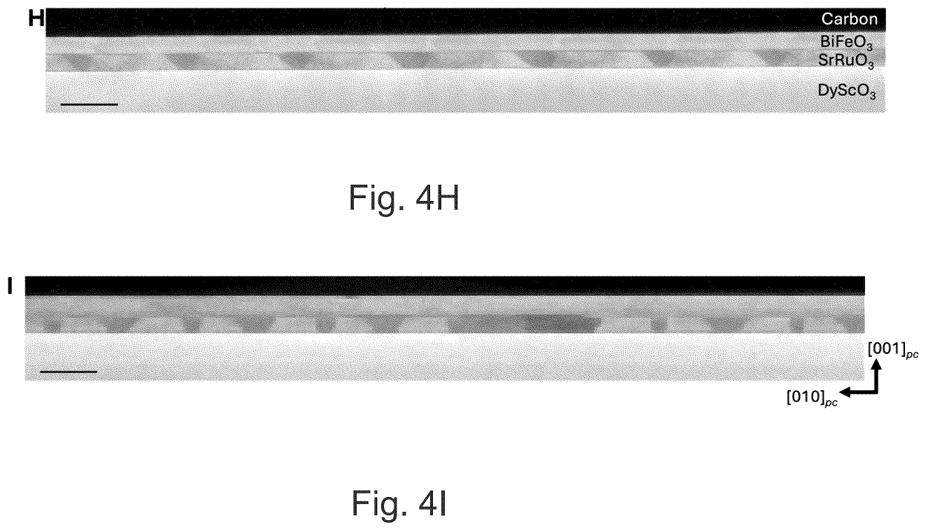

The depth-resolved imaging approach was demonstrated on a heterostructure consisting of 30 nm BiFeO₃ deposited on 30 nm SrRuO₃ grown on a DyScO₃ substrate with out-of-plane orientation of [001]ₒ/[100]_{pc}, with Monte Carlo simulations illustrating how electron generation volumes vary with accelerating voltage—2 kV (green), 5 kV (blue), and 10 kV (red)—to probe different depths within the film stack (FIG. 4A). Voltage-dependent ABS imaging at these three energies revealed the evolution of domain structures through the film thickness, with images acquired at 2 kV, 5 kV, and 10 kV showing consistent stripe-like domain patterns along the z-direction of the thin film in one region (FIG. 4B-D). In contrast, ABS imaging of a frustrated area at the same three voltages exposed significant depth-dependent variations in the polarization domain structure across the film thickness, demonstrating the three-dimensional complexity of the domain configuration (FIG. 4E-G). All plan-view images covered a 500 nm field of view. To corroborate these observations, cross-sectional dark-field (DF) 4D-STEM imaging was performed on both regions, with the stripe region corresponding to the plan-view data revealing periodic twinning patterns in both the BiFeO₃ and SrRuO₃ layers (FIG. 4H), while the frustrated region displayed distinctly distorted twinning patterns that reflected the more complex domain arrangement observed in plan-view (FIG. 4I). These cross-sectional images, with 100 nm scale bars, provided direct visualization of the contrasting domain distributions between ordered and frustrated regions throughout the entire heterostructure thickness.

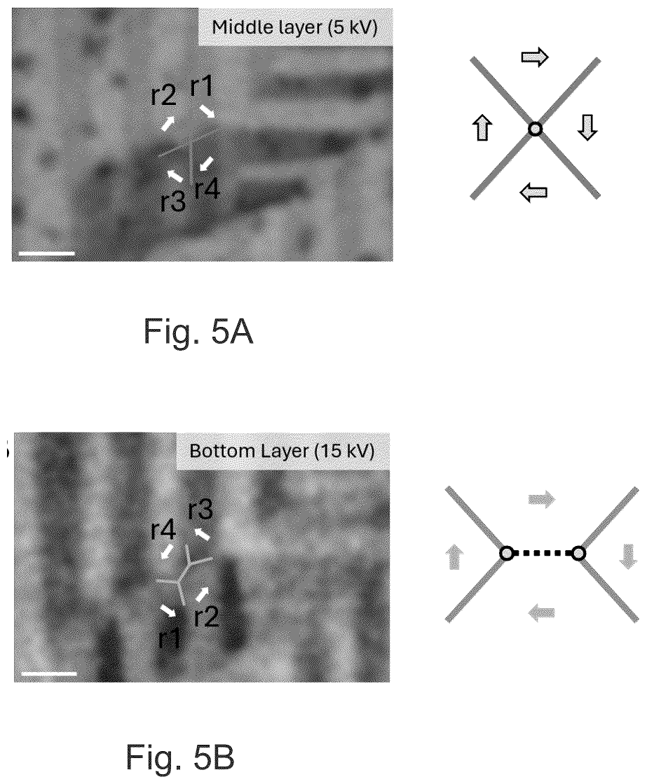

The depth-resolved electron-diffraction imaging (DREDI) technique revealed a remarkable three-dimensional evolution of ferroelectric domains, demonstrating a transition from vertices to vortex structures along the out-of-plane direction. ABS imaging at 5 kV, which probes deeper into the film due to the larger electron interaction volume, exposed two distinct three-fold vertices at the bottom of the film structure (FIG. 5A). In contrast, when the same region was imaged at 15 kV, corresponding to a shallower probing depth near the surface, a fundamentally different domain pattern emerged consisting of a single four-fold vertex (FIG. 5B). The schematic representations in the right column illustrate these contrasting domain configurations—the deeper two three-fold vertices versus the surface-localized four-fold vertex structure. Both images capture a 200 nm field of view, providing clear evidence that the polarization topology undergoes a systematic transformation from bifurcated three-fold vertices near the substrate interface to consolidated four-fold vortex domains closer to the film surface. This depth-dependent evolution of topological defects represents a direct observation of embedded polar vortices within the ferroelectric thin film, highlighting the complex three-dimensional nature of polarization textures in these confined geometries.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### REFERENCES

[1] R. J. Zeches, et al., Science 326 (2009), 977.
[2] D. G. Schlom et al., MRS Bulletin 39 (2014), 118.
[3] A. Winkelmann, G. Nolze, Ultramicroscopy 149 (2015), 58.
[4] M. J. Burch et al., Ultramicroscopy 173 (2017), 47.
[5] Data were acquired at the Core Center of Excellence in Nano Imaging at the University of Southern California. Work supported by the startup funding at USC Viterbi and the USC Research and Innovation Instrumentation Award.
[6] A. L. Marshall, J. Holzer, P. Stejskal, C. J. Stephens, T. Vystavěl, M. J. Whiting, The EBSD spatial resolution of a Timepix-based detector in a tilt-free geometry, Ultramicroscopy, Volume 226, 2021, 113294, ISSN 0304-3991, https://doi.org/10.1016/j.ultramic.2021.113294. (https://www.sciencedirect.com/science/article/pii/S0304399121000826)

What is claimed is:

1. A system for non-destructive, imaging of polar domains and crystallographic symmetry, comprising:
a source of a focused electron beam;
a sample holder configured to orient a sample at a selectable angle relative to the focused electron beam at a probe position;
an imaging detector configured to receive diffracted electrons resolvable into wave-vector components along mutually orthogonal first and second directions;
a translation stage configured to translate the sample holder and thereby sample a plurality of positions on the sample; and
a computer processor-based controller programmed to operate the translation stage, collect output from the imaging detector, and to image and identify polar domains and crystallographic symmetry in the sample.

2. The system of claim 1, further comprising a beam-energy control circuit that supplies the focused electron beam with at least two accelerating-voltage set-points that differ by at least 1 kilovolts and spans a range of landing energies from about 2 kV to about 25 kV, thereby probing successively deeper interaction volumes within the sample.

3. The system of claim 1, wherein the computer processor-based controller configured to register diffraction data acquired at a plurality of accelerating-voltage set-points and to generate tomographic slices of the sample.

4. The system of claim 1, wherein each tomographic slice generated by the computer processor-based controller has a lateral spatial resolution such that structures of size 50 nm or smaller can be resolved and a depth resolution such that structures of size 10 nm or smaller can be resolved.

5. The system of claim 1, wherein the polar domains and the crystallographic symmetry are identified by examining intensity asymmetries in electron backscatter diffraction (EBSD) patterns, interpreting variations in the EBSD patterns to determine an orientation and distribution of the polar domains, and assessing symmetry based on diffraction features and their deviations from expected symmetrical behavior.

6. The system of claim 1, wherein the computer processor-based controller or another computing device is configured to apply clustering analysis to provide contrasts that correspond to different types of Kikuchi patterns.

7. The system of claim 6, wherein the clustering analysis is selected from the group consisting of k-means clustering, hierarchical clustering, density-based spatial clustering of applications with noise (BSCAN), mean shift clustering, agglomerative clustering, balanced iterative reducing and clustering using hierarchies (BIRCH), gaussian mixture model (gmm), ordering points to identify clustering structure (OPTICS), spectral clustering, affinity propagation, and combinations thereof.

8. The system of claim 7, wherein the imaging detector configured to receive the diffracted electrons as one or more electron backscatter diffraction (EBSD) datasets.

9. The system of claim 8, wherein the computer processor-based controller or another computing device is configured to apply principal component analysis (PCA) and/or a k-means clustering to the EBSD datasets.

10. The system of claim 9, wherein PCA is applied to reduce dimensionality of the one or more EBSD datasets by identifying and projecting onto principal components that capture a maximum variance or have a value greater than a predetermined variance, thereby simplifying data while retaining essential features for further analysis.

11. The system of claim 9, wherein the k-means clustering is performed by:
initializing a predetermined number of cluster centroids using an optimized seeding method to improve accuracy of cluster formation;
assigning each data point within imaging data to a nearest cluster centroid based on a distance metric that accounts for specific characteristics of Kikuchi patterns;
updating each cluster centroid by calculating a weighted mean of the data points assigned to a respective centroid, where weights are determined based on intensity and spatial distribution of the Kikuchi patterns; and
iterating the assignment and update steps until a convergence criterion is met, wherein the convergence criterion includes minimizing variance within each cluster and maximizing the variance between clusters, wherein results from k-means clustering provides enhancing contrasts that correspond to different types of Kikuchi patterns, thereby enabling imaging of the polar domains and the crystallographic symmetry in the sample.

12. The system of claim 1, wherein the sample holder is configured to hold the sample at an angle with respect to the focused electron beam.

13. The system of claim 1, wherein the sample holder is configured to hold the sample at an angle from 5 to 75°.

14. The system of claim 1, wherein the sample holder is configured to hold the sample at a normal angle with respect to the focused electron beam.

15. The system of claim 1, wherein when the sample is a non-centrosymmetric crystal with a polar axis lying in a mirror plane in a corresponding Kikuchi pattern, the computer processor-based controller or another computing device is configured to derive polarity from intensity asymmetry.

16. The system of claim 1, wherein the computer processor-based controller or another computing device is configured to compare intensity differences of Kikuchi patterns from a plurality of regions to verify the polar domains and a corresponding breaking of Friedel symmetry.

17. The system of claim 1, wherein the imaging detector is selected from the group consisting of CMOS cameras, scintillation screen/phosphor screen detectors, photographic film, image plates, microchannel plate detectors, electron-induced fluorescence detectors, electron energy-loss spectroscopy detectors, electron-beam position-sensitive detectors, electron-backscatter diffraction detectors, and combinations thereof.

18. The system of claim 1, wherein the sample holder holds the sample normally with respect to the focused electron beam and wherein the imaging detector includes a plurality of image-sensing elements.

19. The system of claim 1, wherein the imaging detector includes a Timepix detector.

20. The system of claim 1, wherein the sample is a ferromagnet.

21. A method for non-destructive imaging of polar domains and crystallographic symmetry, comprising:
directing a focused electron beam onto a sample held at a probe position by a sample holder, the sample holder maintaining the sample at an angle with respect to the focused electron beam;
receiving diffracted electrons from the sample with an imaging detector that resolves them into a first wave vector component along a first direction and a second wave vector component along a second direction, wherein the first direction is orthogonal to the second direction;
moving the sample holder to sample a plurality of positions from the sample using a translation stage;
collecting output from the imaging detector with a computer processor-based controller; and
imaging and/or identifying the polar domains and the crystallographic symmetry in the sample using the computer processor-based controller or another computing device.

22. The method of claim 21, further comprising stepping an electron landing energy through a plurality of values between 2 kV and 25 kV, wherein for each voltage, acquiring an EBSD or ABS dataset is acquired and stored in association with interaction-depth metadata.

23. The method of claim 21, further comprising identifying the polar domains and the crystallographic symmetry by examining intensity asymmetries in electron backscatter diffraction (EBSD) patterns, interpreting variations in the EBSD patterns to determine an orientation and distribution of the polar domains, and assessing symmetry based on diffraction features and their deviations from expected symmetrical behavior.

24. The method of claim 21, further comprising applying clustering analysis using the computer processor-based controller or another computing device to provide contrasts that correspond to different types of Kikuchi patterns.

25. The method of claim 21, wherein the clustering analysis is selected from the group consisting of k-means clustering, hierarchical clustering, density-based spatial clustering of applications with noise (BSCAN), mean shift clustering, agglomerative clustering, balanced iterative reducing and clustering using hierarchies (BIRCH), Gaussian mixture model (GMM), ordering points to identify clustering structure (OPTICS), spectral clustering, affinity propagation, and combinations thereof.

26. The method of claim 21, further comprising receiving the diffracted electrons as one or more electron backscatter diffraction (EBSD) datasets with the imaging detector.

27. The method of claim 26, further comprising applying principal component analysis (PCA) and/or k-means clustering to the EBSD datasets using the computer processor-based controller or another computing device.

28. The method of claim 27, wherein PCA is applied to reduce dimensionality of the one or more EBSD datasets by identifying and projecting onto principal components that capture maximum variance or have a value greater than a predetermined variance, thereby simplifying data while retaining essential features for further analysis.

29. The method of claim 28, wherein k-means clustering is performed by:
initializing a predetermined number of cluster centroids using an optimized seeding method to improve accuracy of cluster formation;
assigning each data point within imaging data to a nearest cluster centroid based on a distance metric that accounts for specific characteristics of Kikuchi patterns;
updating each cluster centroid by calculating a weighted mean of the data points assigned to a respective centroid, where weights are determined based on intensity and spatial distribution of the Kikuchi patterns; and
iterating the assignment and update steps until a convergence criterion is met, wherein the convergence criterion includes minimizing variance within each cluster and maximizing the variance between clusters, thereby enhancing contrasts that correspond to different types of Kikuchi patterns and enabling imaging of the polar domains and the crystallographic symmetry in the sample.

30. The method of claim 21, further comprising deriving polarity from intensity asymmetry when the sample is a non-centrosymmetric crystal with a polar axis lying in a mirror plane in a corresponding Kikuchi pattern, using the computer processor-based controller or another computing device.

31. The method of claim 21, further comprising comparing intensity differences of Kikuchi patterns from a plurality of regions to verify the polar domains and a corresponding breaking of Friedel symmetry using the computer processor-based controller or another computing device.
